(19) United States
(12) Patent Application Publication
(10) Pub. No.: US 2011/0077364 A1
(43) Pub. Date: Mar. 31, 2011

(54) COMPOSITION CONTAINING SILICON-CONTAINING POLYMER, CURED PRODUCT OF THE COMPOSITION, SILICON-CONTAINING POLYMER, AND METHOD OF PRODUCING THE SILICON-CONTAINING POLYMER

(75) Inventors: Taichi TAZAKI, Tokyo (JP); Kinji Yamada, Tokyo (JP); Tarou Kanamori, Tokyo (JP); Keisuke Yajima, Tokyo (JP)

(73) Assignee: JSR Corporation, Tokyo (JP)

(21) Appl. No.: 12/894,149

(22) Filed: Sep. 30, 2010

Related U.S. Application Data
(63) Continuation of application No. PCT/JP2009/056227, filed on Mar. 27, 2009.

(30) Foreign Application Priority Data
Apr. 2, 2008 (JP) 2008-096214

(51) Int. Cl. C08G 77/32; C08L 83/04

(52) U.S. Cl. 525/477; 525/474

(57) ABSTRACT

A composition includes a curing agent and a silicon-containing polymer. The silicon-containing polymer includes a structural unit (A1) and a structural unit (A2). The structural unit (A1) is shown by a formula (1), in which each of R¹ represents a monovalent hydrocarbon group having 1 to 6 carbon atoms, each of X represents a divalent hydrocarbon group having 1 to 7 carbon atoms, and n is an integer from 1 to 6. The structural unit (A2) is shown by a formula (2), in which R² represents a monovalent hydrocarbon group having 1 to 6 carbon atoms, R³ represents a monovalent hydrocarbon group having 1 to 6 carbon atoms, a halogen atom, or a reactive functional group, and m is a positive integer. The structural unit (A1) and the structural unit (A2) have a weight ratio (A1):(A2) of 4:96 to 70:30.

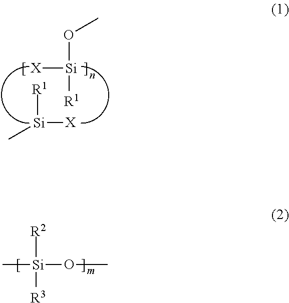

### CROSS-REFERENCE TO RELATED APPLICATIONS

The present application is a continuation application of International Application No. PCT/JP2009/056227, filed Mar. 27, 2009, which claims priority to Japanese Patent Application No. 2008-096214, filed Apr. 2, 2008. The contents of these applications are incorporated herein by reference in their entirety.

### BACKGROUND OF THE INVENTION

1. Technical Field

The present invention relates to a composition containing a silicon-containing polymer, a cured product of the composition, the silicon-containing polymer, and a method of producing the silicon-containing polymer.

2. Background Art

A cured product that exhibits high durability can be obtained by curing a composition including a polymer that includes silicon in the main chain (hereinafter referred to as “silicon-containing polymer”). Therefore, the silicon-containing polymer has been used as a coating material and the like.

As the silicon-containing polymer, a polycarbosilane that includes a silicon atom and a carbon atom in the main chain, a polysiloxane that includes a silicon atom and an oxygen atom in the main chain, and the like have been known.

A carbosilane-based material exhibits excellent gas barrier properties and excellent adhesion to an organic substrate. On the other hand, a polysiloxane-based material can produce a film having a thickness of the order of millimeters.

However, a silicon-containing polymer that may be used for a composition that exhibits excellent gas barrier properties and excellent adhesion to an organic substrate, and can produce a cured product having a large thickness, has not been known.

### SUMMARY OF THE INVENTION

According to one aspect of the invention, a composition includes a curing agent and a silicon-containing polymer. The silicon-containing polymer includes a structural unit (A1) shown by a following formula (1) and a structural unit (A2) shown by a following formula (2). The structural unit (A1) and the structural unit (A2) have a weight ratio (A1):(A2) of 4:96 to 70:30.

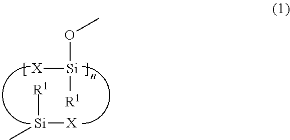

wherein each of R¹ represents a monovalent hydrocarbon group having 1 to 6 carbon atoms, each of X represents a divalent hydrocarbon group having 1 to 7 carbon atoms, and n is an integer from 1 to 6.

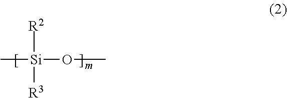

wherein R² represents a monovalent hydrocarbon group having 1 to 6 carbon atoms, R³ represents one of a monovalent hydrocarbon group having 1 to 6 carbon atoms, a halogen atom, and a reactive functional group, and m is a positive integer.

According to another aspect of the invention, a composition includes a curing agent and a silicon-containing polymer. The silicon-containing polymer includes a structural unit (A3) shown by a following formula (3).

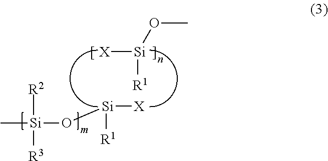

wherein each of R¹ represents a monovalent hydrocarbon group having 1 to 6 carbon atoms, each of X represents a divalent hydrocarbon group having 1 to 7 carbon atoms, each of R² and R³ represents a monovalent hydrocarbon group having 1 to 6 carbon atoms, n is an integer from 1 to 6, and m is a positive integer.

According to still another aspect of the invention, a silicon-containing polymer includes a structural unit (A1) shown by a following formula (1) and a structural unit (A2) shown by a following formula (2). The structural unit (A1) and the structural unit (A2) have a weight ratio (A1):(A2) of 4:96 to 70:30.

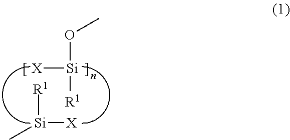

wherein each of R¹ represents a monovalent hydrocarbon group having 1 to 6 carbon atoms, each of X represents a divalent hydrocarbon group having 1 to 7 carbon atoms, and n is an integer from 1 to 6.

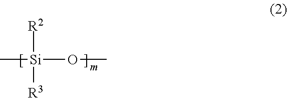

wherein R² represents a monovalent hydrocarbon group having 1 to 6 carbon atoms, R³ represents one of a monovalent hydrocarbon group having 1 to 6 carbon atoms, a halogen atom, and a reactive functional group, and m is a positive integer.

According to the other aspect of the invention, a method of producing a silicon-containing polymer includes reacting a compound shown by a following formula (4) with a polyorganosiloxane shown by a following formula (5).

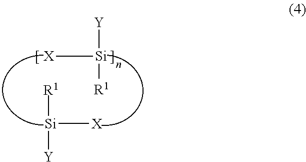

wherein each of R¹ represents a monovalent hydrocarbon group having 1 to 6 carbon atoms, each of X represents a divalent hydrocarbon group having 1 to 7 carbon atoms, Y represents a reactive functional group, and n is an integer from 1 to 6.

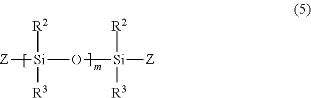

wherein each of R² represents a monovalent hydrocarbon group having 1 to 6 carbon atoms, each of R³ represents one of a monovalent hydrocarbon group having 1 to 6 carbon atoms, a halogen atom, and a reactive functional group, each of Z represents one of a halogen atom and a reactive functional group, and m is a positive integer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view showing the NMR analysis results for a hybrid polymer of Example 4.

### DESCRIPTION OF THE EMBODIMENTS

The embodiments will now be described with reference to the accompanying drawings.

### <Composition>

A composition according to one embodiment of the invention includes (A) a silicon-containing polymer, and (B) a curing agent.

Silicon-containing polymer (A)

Examples of the silicon-containing polymer (A) include a polymer including (A1) a structural unit shown by the following formula (1) and (A2) a structural unit shown by the following formula (2), and a polymer including (A3) a structural unit shown by the following formula (3).

It is preferable that the silicon-containing polymer (A) include the structural unit (A1) and the structural unit (A2) in a weight ratio (A1):(A2) of 4:96 to 70:30. The weight ratio (A1):(A2) is more preferably 10:90 to 60:40, and particularly preferably 15:85 to 50:50. If the weight ratio of the structural unit (A1) to the structural unit (A2) is lower than 4:96, the composition may exhibit poor curability. If the weight ratio of the structural unit (A1) to the structural unit (A2) is higher than 70:30, cracks may occur during curing.

The polystyrene-reduced weight average molecular weight of the silicon-containing polymer (A) determined by gel permeation chromatography is preferably 500 to 1,000,000, more preferably 1000 to 500,000, and particularly preferably 1500 to 100,000.

### Structural Unit (A1)

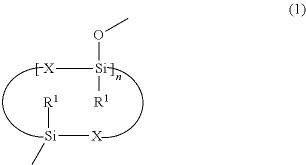

wherein R¹ represents a monovalent hydrocarbon group having 1 to 6 carbon atoms. Examples of the hydrocarbon group include an alkyl group, an alkenyl group, an aryl group, and the like. Examples of the alkyl group include a methyl group, an ethyl group, a propyl group, a butyl group, and the like. Examples of the alkenyl group include a vinyl group, an allyl group, and the like. Examples of the aryl group include a phenyl group and the like.

X represents a divalent hydrocarbon group having 1 to 7 carbon atoms. Specific examples of the hydrocarbon group represented by X include a methylene group, an ethylene group, a propylene group, a butylene group, and the like.

n is an integer from 1 to 6. n is preferably an integer from 1 to 3.

Structural unit (A2)

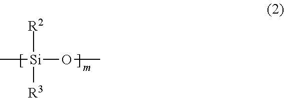

wherein R² represents a monovalent hydrocarbon group having 1 to 6 carbon atoms, and R³ represents one of a monovalent hydrocarbon group having 1 to 6 carbon atoms, a halogen atom, and a reactive functional group. Examples of the hydrocarbon group include an alkyl group, an alkenyl group, an aryl group, and the like. Examples of the alkyl group include a methyl group, an ethyl group, a propyl group, a butyl group, and the like. Examples of the alkenyl group include a vinyl group, an allyl group, and the like. Examples of the aryl group include a phenyl group and the like. Examples of the halogen atom include a chlorine atom, a bromine atom, and the like. Examples of the reactive functional group include a hydroxyl group, a carbinol group, an amino group, an isocyanate group, a carboxyl group, a substituent derived from a carboxyl group, an alkoxy group, a mercapto group, a sulfo group, a substituent derived from a sulfo group, a sulfinic acid group, a hydrido group, a vinyl group, and the like. It is particularly preferable that R² and R³ be methyl groups.

m is a positive integer. m is preferably an integer from 5 to 10,000.

The number average molecular weight (g/mol) of the structural unit (A2) is preferably 100 to 1,000,000.

### Structural Unit (A3)

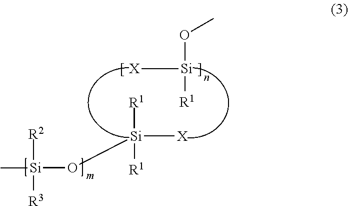

wherein each of R¹ represents a monovalent hydrocarbon group having 1 to 6 carbon atoms, each of X represents a divalent hydrocarbon group having 1 to 7 carbon atoms, each of R² and R³ represents a monovalent hydrocarbon group having 1 to 6 carbon atoms, and m is a positive integer. Specific examples and preferable examples of R¹, R², R³, n, and m in the formula (3) are the same as described above.

### Additional Constituent Unit

The silicon-containing polymer (A) may include a constituent unit derived from at least one of the following silane compounds as an additional constituent unit.

Specific examples of the silane compound include tetramethoxysilane, tetraethoxysilane, tetra-n-propoxysilane, tetra-i-propoxysilane, tetra-n-butoxysilane, tetra-sec-butoxysilane, tetra-t-butoxysilane, tetraphenoxysilane, trimethoxysilane, triethoxysilane, tri-n-propoxysilane, tri-i-propoxysilane, tri-n-butoxysilane, tri-sec-butoxysilane, tri-t-butoxysilane, triphenoxysilane, fluorotrimethoxysilane, fluorotriethoxysilane, fluorotri-n-propoxysilane, fluorotri-i-propoxysilane, fluorotri-n-butoxysilane, fluorotri-sec-butoxysilane, fluorotri-t-butoxysilane, fluorotriphenoxysilane, methyltrimethoxysilane, methyltriethoxysilane, methyltri-n-propoxysilane, methyltri-i-propoxysilane, methyltri-n-butoxysilane, methyltri-sec-butoxysilane, methyltri-t-butoxysilane, methyltriphenoxysilane, ethyltrimethoxysilane, ethyltriethoxysilane, ethyltri-n-propoxysilane, ethyltri-i-propoxysilane, ethyltri-n-butoxysilane, ethyltri-sec-butoxysilane, ethyltri-t-butoxysilane, ethyltriphenoxysilane, vinyltrimethoxysilane, vinyltriethoxysilane, vinyltri-n-propoxysilane, vinyltri-i-propoxysilane, vinyltri-n-butoxysilane, vinyltri-sec-butoxysilane, vinyltri-t-butoxysilane, vinyltriphenoxysilane, n-propyltrimethoxysilane, n-propyltriethoxysilane, n-propyltri-n-propoxysilane, n-propyltri-i-propoxysilane, n-propyltri-n-butoxysilane, n-propyltri-sec-butoxysilane, n-propyltri-t-butoxysilane, n-propyltriphenoxysilane, i-propyltrimethoxysilane, i-propyltriethoxysilane, i-propyltri-n-propoxysilane, i-propyltri-i-propoxysilane, i-propyltri-n-butoxysilane, i-propyltri-sec-butoxysilane, i-propyltri-t-butoxysilane, i-propyltriphenoxysilane, n-butyltrimethoxysilane, n-butyltriethoxysilane, n-butyltri-n-propoxysilane, n-butyltri-i-propoxysilane, n-butyltri-n-butoxysilane, n-butyltri-sec-butoxysilane, n-butyltri-t-butoxysilane, n-butyltriphenoxysilane, sec-butyltrimethoxysilane, sec-butyltriethoxysilane, sec-butyl-tri-n-propoxysilane, sec-butyl-tri-i-propoxysilane, sec-butyl-tri-n-butoxysilane, sec-butyl-tri-sec-butoxysilane, sec-butyl-tri-t-butoxysilane, sec-butyl-triphenoxysilane, t-butyltrimethoxysilane, t-butyltriethoxysilane, t-butyltri-n-propoxysilane, t-butyltri-i-propoxysilane, t-butyltri-n-butoxysilane, t-butyltri-sec-butoxysilane, t-butyltri-t-butoxysilane, t-butyltriphenoxysilane, phenyltrimethoxysilane, phenyltriethoxysilane, phenyltri-n-propoxysilane, phenyltri-i-propoxysilane, phenyltri-n-butoxysilane, phenyltri-sec-butoxysilane, phenyltri-t-butoxysilane, phenyltriphenoxysilane, vinyltrimethoxysilane, vinyltriethoxysilane, γ-aminopropyltrimethoxysilane, γ-aminopropyltriethoxysilane, γ-glycidoxypropyltrimethoxysilane, γ-glycidoxypropyltriethoxysilane, γ-trifluoropropyltrimethoxysilane, γ-trifluoropropyltriethoxysilane, dimethyldimethoxysilane, dimethyldiethoxysilane, dimethyl-di-n-propoxysilane, dimethyl-di-i-propoxysilane, dimethyl-di-n-butoxysilane, dimethyl-di-sec-butoxysilane, dimethyl-di-t-butoxysilane, dimethyldiphenoxysilane, diethyldimethoxysilane, diethyldiethoxysilane, diethyl-di-n-propoxysilane, diethyl-di-i-propoxysilane, diethyl-di-n-butoxysilane, diethyl-di-sec-butoxysilane, diethyl-di-t-butoxysilane, diethyldiphenoxysilane, di-n-propyldimethoxysilane, di-n-propyldiethoxysilane, di-n-propyl-di-n-propoxysilane, di-n-propyl-di-i-propoxysilane, di-n-propyl-di-n-butoxysilane, di-n-propyl-di-sec-butoxysilane, di-n-propyl-di-t-butoxysilane, di-n-propyl-di-phenoxysilane, di-i-propyldimethoxysilane, di-i-propyldiethoxysilane, di-i-propyl-di-n-propoxysilane, di-i-propyl-di-i-propoxysilane, di-i-propyl-di-n-butoxysilane, di-i-propyl-di-sec-butoxysilane, di-i-propyl-di-t-butoxysilane, di-i-propyl-di-phenoxysilane, di-n-butyldimethoxysilane, di-n-butyldiethoxysilane, di-n-butyl-di-n-propoxysilane, di-n-butyl-di-i-propoxysilane, di-n-butyl-di-n-butoxysilane, di-n-butyl-di-sec-butoxysilane, di-n-butyl-di-t-butoxysilane, di-n-butyl-di-phenoxysilane, di-sec-butyldimethoxysilane, di-sec-butyldiethoxysilane, di-sec-butyl-di-n-propoxysilane, di-sec-butyl-di-i-propoxysilane, di-sec-butyl-di-n-butoxysilane, di-sec-butyl-di-sec-butoxysilane, di-sec-butyl-di-t-butoxysilane, di-sec-butyl-di-phenoxysilane, di-t-butyldimethoxysilane, di-t-butyldiethoxysilane, di-t-butyl-di-n-propoxysilane, di-t-butyl-di-i-propoxysilane, di-t-butyl-di-n-butoxysilane, di-t-butyl-di-sec-butoxysilane, di-t-butyl-di-t-butoxysilane, di-t-butyl-di-phenoxysilane, diphenyldimethoxysilane, diphenyl-di-ethoxysilane, diphenyl-di-n-propoxysilane, diphenyl-di-i-propoxysilane, diphenyl-di-n-butoxysilane, diphenyl-di-sec-butoxysilane, diphenyl-di-t-butoxysilane, diphenyldiphenoxysilane, divinyltrimethoxysilane, tetrachlorosilane, tetrabromosilane, tetraiodosilane, trichlorosilane, tribromosilane, triiodosilane, methyltrichlorosilane, ethyltrichlorosilane, n-propyltrichlorosilane, isopropyltrichlorosilane, n-butyltrichlorosilane, t-butyltrichlorosilane, cyclohexyltrichlorosilane, phenethyltrichlorosilane, 2-norbornyltrichlorosilane, vinyltrichlorosilane, phenyltrichlorosilane, methyltribromosilane, ethyltribromosilane, n-propyltribromosilane, isopropyltribromosilane, n-butyltribromosilane, t-butyltribromosilane, cyclohexyltribromosilane, phenethyltribromosilane, 2-norbornyltribromosilane, vinyltribromosilane, phenyltribromosilane, methyltriiodosilane, ethyltriiodosilane, n-propyltriiodosilane, isopropyltriiodosilane, n-butyltriiodosilane, t-butyltriiodosilane, cyclohexyltriiodosilane, phenethyltriiodosilane, 2-norbornyltriiodosilane, vinyltriiodosilane, phenyltriiodosilane, dimethyldichlorosilane, diethyldichlorosilane, di-n-propyldichlorosilane, diisopropyldichlorosilane, di-n-butyldichlorosilane, di-t-butyldichlorosilane, dicyclohexyldichlorosilane, diphenethyldichlorosilane, di-2-norbornyldichlorosilane, divinyldichlorosilane, diphenyldichlorosilane, dimethyldibromosilane, diethyldibromosilane, di-n-propyldibromosilane, diisopropyldibromosilane, di-n-butyldibromosilane, di-t-butyldibromosilane, dicyclohexyldibromosilane, diphenethyldibromosilane, di-2-norbornyldibromosilane, divinyldibromosilane, diphenyldibromosilane, dimethyldiiodosilane, diethyldiiodosilane, di-n-propyldiiodosilane, diisopropyldiiodosilane, di-n-butyldiiodosilane, di-t-butyldiiodosilane, dicyclohexyldiiodosilane, diphenethyldiiodosilane, di-2-norbornyldiiodosilane, divinyldiiodosilane, diphenyldiiodosilane, trimethylchlorosilane, triethylchlorosilane, tri-n-propylchlorosilane, triisopropylchlorosilane, tri-n-butylchlorosilane, tri-t-butylchlorosilane, tricyclohexylchlorosilane, triphenethylchlorosilane, tri-2-norbornylchlorosilane, trivinylchlorosilane, triphenylchlorosilane, trimethylbromosilane, triethylbromosilane, tri-n-propylbromosilane, triisopropylbromosilane, tri-n-butylbromosilane, tri-t-butylbromosilane, tricyclohexylbromosilane, triphenethylbromosilane, tri-2-norbornylbromosilane, trivinylbromosilane, triphenylbromosilane, trimethyliodosilane, triethyliodosilane, tri-n-propyliodosilane, triisopropyliodosilane, tri-n-butyliodosilane, tri-t-butyliodosilane, tricyclohexyliodosilane, triphenethyliodosilane, tri-2-norbornyliodosilane, trivinyliodosilane, triphenyliodosilane, hexachlorodisiloxane, hexabromodisiloxane, hexaiodedisiloxane, hexamethoxydisiloxane, hexaethoxydisiloxane, hexaphenoxydisiloxane, 1,1,1,3,3-pentamethoxy-3-methyldisiloxane, 1,1,1,3,3-pentaethoxy-3-methyldisiloxane, 1,1,1,3,3-pentaphenoxy-3-methyldisiloxane, 1,1,1,3,3-pentamethoxy-3-ethyldisiloxane, 1,1,1,3,3-pentaethoxy-3-ethyldisiloxane, 1,1,1,3,3-pentaphenoxy-3-ethyldisiloxane, 1,1,1,3,3-pentamethoxy-3-phenyldisiloxane, 1,1,1,3,3-pentaethoxy-3-phenyldisiloxane, 1,1,1,3,3-pentaphenoxy-3-phenyldisiloxane, 1,1,3,3-tetramethoxy-1,3-dimethyldisiloxane, 1,1,3,3-tetraethoxy-1,3-dimethyldisiloxane, 1,1,3,3-tetraphenoxy-1,3-dimethyldisiloxane, 1,1,3,3-tetramethoxy-1,3-diethyldisiloxane, 1,1,3,3-tetraethoxy-1,3-diethyldisiloxane, 1,1,3,3-tetraphenoxy-1,3-diethyldisiloxane, 1,1,3,3-tetramethoxy-1,3-diphenyldisiloxane, 1,1,3,3-tetraethoxy-1,3-diphenyldisiloxane, 1,1,3,3-tetraphenoxy-1,3-diphenyldisiloxane, 1,1,3-trimethoxy-1,3,3-trimethyldisiloxane, 1,1,3-triethoxy-1,3,3-trimethyldisiloxane, 1,1,3-triphenoxy-1,3,3-trimethyldisiloxane, 1,1,3-trimethoxy-1,3,3-triethyldisiloxane, 1,1,3-triethoxy-1,3,3-triethyldisiloxane, 1,1,3-triphenoxy-1,3,3-triethyldisiloxane, 1,1,3-trimethoxy-1,3,3-triphenyldisiloxane, 1,1,3-triethoxy-1,3,3-triphenyldisiloxane, 1,1,3-triphenoxy-1,3,3-triphenyldisiloxane, 1,3-dimethoxy-1,1,3,3-tetramethyldisiloxane, 1,3-diethoxy-1,1,3,3-tetramethyldisiloxane, 1,3-diphenoxy-1,1,3,3-tetramethyldisiloxane, 1,3-dimethoxy-1,1,3,3-tetraethyldisiloxane, 1,3-diethoxy-1,1,3,3-tetraethyldisiloxane, 1,3-diphenoxy-1,1,3,3-tetraethyldisiloxane, 1,3-dimethoxy-1,1,3,3-tetraphenyldisiloxane, 1,3-diethoxy-1,1,3,3-tetraphenyldisiloxane, 1,3-diphenoxy-1,1,3,3-tetraphenyldisiloxane, hexachlorodisilane, hexabromodisilane, hexaiodedisilane, hexamethoxydisilane, hexaethoxydisilane, hexaphenoxydisilane, 1,1,1,2,2-pentamethoxy-2-methyldisilane, 1,1,1,2,2-pentaethoxy-2-methyldisilane, 1,1,1,2,2-pentaphenoxy-2-methyldisilane, 1,1,1,2,2-pentamethoxy-2-ethyldisilane, 1,1,1,2,2-pentaethoxy-2-ethyldisilane, 1,1,1,2,2-pentaphenoxy-2-ethyldisilane, 1,1,1,2,2-pentamethoxy-2-phenyldisilane, 1,1,1,2,2-pentaethoxy-2-phenyldisilane, 1,1,1,2,2-pentaphenoxy-2-phenyldisilane, 1,1,2,2-tetramethoxy-1,2-dimethyldisilane, 1,1,2,2-tetraethoxy-1,2-dimethyldisilane, 1,1,2,2-tetraphenoxy-1,2-dimethyldisilane,

1,1,2,2-tetramethoxy-1,2-diethyldisilane, 1,1,2,2-tetraethoxy-1,2-diethyldisilane, 1,1,2,2-tetraphenoxy-1,2-diethyldisilane, 1,1,2,2-tetramethoxy-1,2-diphenyldisilane, 1,1,2,2-tetraethoxy-1,2-diphenyldisilane, 1,1,2,2-tetraphenoxy-1,2-diphenyldisilane, 1,1,2-trimethoxy-1,2,2-trimethyldisilane, 1,1,2-triethoxy-1,2,2-trimethyldisilane, 1,1,2-triphenoxy-1,2,2-trimethyldisilane, 1,1,2-trimethoxy-1,2,2-triethyldisilane, 1,1,2-triethoxy-1,2,2-triethyldisilane, 1,1,2-triphenoxy-1,2,2-triethyldisilane, 1,1,2-trimethoxy-1,2,2-triphenyldisilane, 1,1,2-triethoxy-1,2,2-triphenyldisilane, 1,1,2-triphenoxy-1,2,2-triphenyldisilane, 1,2-dimethoxy-1,1,2,2-tetramethyldisilane, 1,2-diethoxy-1,1,2,2-tetramethyldisilane, 1,2-diphenoxy-1,1,2,2-tetramethyldisilane, 1,2-dimethoxy-1,1,2,2-tetraethyldisilane, 1,2-diethoxy-1,1,2,2-tetraethyldisilane, 1,2-diphenoxy-1,1,2,2-tetraethyldisilane, 1,2-dimethoxy-1,1,2,2-tetraphenyldisilane, 1,2-diethoxy-1,1,2,2-tetraphenyldisilane, 1,2-diphenoxy-1,1,2,2-tetraphenyldisilanebis(trichlorosilyl)methane, bis(tribromosilyl)methane, bis(triiodosilyl)methane, bis(trichlorosilyl)ethane, bis(tribromosilyl)ethane, bis(triiodosilyl)ethane, bis(trimethoxysilyl)methane, bis(triethoxysilyl)methane, bis(tri-n-propoxysilyl)methane, bis(tri-i-propoxysilyl)methane, bis(tri-n-butoxysilyl)methane, bis(tri-sec-butoxysilyl)methane, bis(tri-t-butoxysilyl)methane, 1,2-bis(trimethoxysilyl)ethane, 1,2-bis(triethoxysilyl)ethane, 1,2-bis(tri-n-propoxysilyl)ethane, 1,2-bis(tri-i-propoxysilyl)ethane, 1,2-bis(tri-n-1,butoxysilyl)ethane, 1,2-bis(tri-sec-butoxysilyl)ethane, 1,1,2,2-bis(tri-t-butoxysilyl)ethane, 1-(dimethoxymethylsilyl)-1-(trimethoxysilyl)methane, 1-(diethoxymethylsilyl)-1-(triethoxysilyl)methane, 1-(di-n-propoxymethylsilyl)-1-(tri-n-propoxysilyl)methane, 1-(di-i-propoxymethylsilyl)-1-(tri-i-propoxysilyl)methane, 1-(di-n-butoxymethylsilyl)-1-(tri-n-butoxysilyl)methane, 1-(di-sec-butoxymethylsilyl)-1-(tri-sec-butoxysilyl)methane, 1-(di-t-butoxymethylsilyl)-1-(tri-t-butoxysilyl)methane, 1-(dimethoxymethylsilyl)-2-(trimethoxysilyl)ethane, 1-(diethoxymethylsilyl)-2-(triethoxysilyl)ethane, 1-(di-n-propoxymethylsilyl)-2-(tri-n-propoxysilyl)ethane, 1-(di-i-propoxymethylsilyl)-2-(tri-i-propoxysilyl)ethane, 1-(di-n-butoxymethylsilyl)-2-(tri-n-butoxysilyl)ethane, 1-(di-sec-butoxymethylsilyl)-2-(tri-sec-butoxysilyl)ethane, 1-(di-t-butoxymethylsilyl)-2-(tri-t-butoxysilyl)ethane, bis(dimethoxymethylsilyl)methane, bis(diethoxymethylsilyl)methane, bis(di-n-propoxymethylsilyl)methane, bis(di-i-propoxymethylsilyl)methane, bis(di-n-butoxymethylsilyl)methane, bis(di-sec-butoxymethylsilyl)methane, bis(di-t-butoxymethylsilyl)methane, 1,2-bis(dimethoxymethylsilyl)ethane, 1,2-bis(diethoxymethylsilyl)ethane, 1,2-bis(di-n-propoxymethylsilyl)ethane, 1,2-bis(di-i-propoxymethylsilyl)ethane, 1,2-bis(di-n-butoxymethylsilyl)ethane, 1,2-bis(di-sec-butoxymethylsilyl)ethane, 1,2-bis(di-t-butoxymethylsilyl)ethane, 1,2-bis(trimethoxysilyl)benzene, 1,2-bis(triethoxysilyl)benzene, 1,2-bis(tri-n-propoxysilyl)benzene, 1,2-bis(tri-i-propoxysilyl)benzene, 1,2-bis(tri-n-butoxysilyl)benzene, 1,2-bis(tri-sec-butoxysilyl)benzene, 1,2-bis(tri-t-butoxysilyl)benzene, 1,3-bis(trimethoxysilyl)benzene, 1,3-bis(triethoxysilyl)benzene, 1,3-bis(tri-n-propoxysilyl)benzene, 1,3-bis(tri-i-propoxysilyl)benzene, 1,3-bis(tri-n-butoxysilyl)benzene, 1,3-bis(tri-sec-butoxysilyl)benzene, 1,3-bis(tri-t-butoxysilyl)benzene, 1,4-bis(trimethoxysilyl)benzene, 1,4-bis(triethoxysilyl)benzene, 1,4-bis(tri-n-propoxysilyl)benzene, 1,4-bis(tri-i-propoxysilyl)benzene, 1,4-bis(tri-n-butoxysilyl)benzene, 1,4-bis(tri-sec-butoxysilyl)benzene, 1,4-bis(tri-t-butoxysilyl)benzene, and the like. The constituent units derived from these compounds may be used either individually or in combination.

Production of silicon-containing polymer (A)

The silicon-containing polymer (A) (hereinafter may be referred to as “hybrid polymer”) may be produced by copolymerizing (a1) a compound that may form the structural unit (A1) shown by the formula (1) with (a2) a polyorganosiloxane that may form the structural unit (A2) shown by the formula (2).

Compound (a1)

The compound (a1) has a structure shown by the following formula (4), for example.

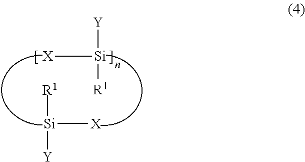

The compound (a1) shown by the formula (4) is a cyclic carbosilane compound (silane compound that includes an Si—C bond on the ring), and is preferably a silane compound having a 4 to 56-membered ring.

R¹ in the formula (4) represents a monovalent hydrocarbon group having 1 to 6 carbon atoms. Examples of the hydrocarbon group include an alkyl group, an alkenyl group, an aryl group, and the like. Examples of the alkyl group include a methyl group, an ethyl group, a propyl group, a butyl group, and the like. Examples of the alkenyl group include a vinyl group, an allyl group, and the like. Examples of the aryl group include a phenyl group and the like.

X in the formula (4) represents a divalent hydrocarbon group having 1 to 7 carbon atom. The number of carbon atoms of the hydrocarbon group represented by X is preferably 4 or less from the viewpoint of thermal stability. Specific examples of the hydrocarbon group represented by X include a methylene group, an ethylene group, a propylene group, a butylene group, and the like.

Y in the formula (4) represents a reactive functional group. Examples of the reactive functional group include a hydroxyl group, a carbinol group, an amino group, an isocyanate group, a carboxyl group, a substituent derived from a carboxyl group, an alkoxy group, a mercapto group, a sulfo group, a substituent derived from a sulfo group, a sulfinic acid group, a hydrido group, a vinyl group, and the like. The compound (a1) may include one or more types of reactive functional groups.

n is an integer from 1 to 6. n is preferably an integer from 1 to 3.

Specific examples of the compound (a1) include 1,3-dimethyl-1,3-dichlorodisilacyclobutane, 1-chloro-1-methyl-1-silacyclobutane, 1-chloro-1-methyl-1-silacyclopentane, 1-chloro-1-methyl-1-silacyclohexane, 1,1-diethoxy-1,3-dimethyl-1,3-disilacyclobutane, 1,3-dichloro-1,3-dimethylsilacyclobutane, 1,3-dimethyl-1,3-diphenyl1,3-disilacyclobutane, 1,1-dimethyl-1-silacyclobutane, 1,1-dimethyl-1-silacyclopentane, 1,1-dimethylsilacyclohexane, 1,1-dimethoxy-1-silacyclobutane, methyl-1-silacyclobutane, 1-methyl-1-silacyclohexane, 1-methyl-silacyclopentane, 1-methyl-1-silacyclohexane, 1-methyl-1-silacyclopentane, 1,1,3,3-tetrachloro-1,3-disilacyclobutane, 1,1,3,3-tetraethoxy-1,3-disilacyclobutane, and 1,1,3,3-tetramethyl-1,3-disilacyclobutane. Among these, 1,3-dimethyl-1,3-dichlorodisilacyclobutane is preferable.

Polyorganosiloxane (a2)

The polyorganosiloxane (a2) has a structure shown by the following formula (5), for example.

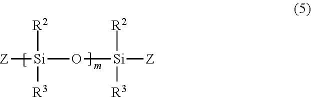

wherein each of R² represents a monovalent hydrocarbon group having 1 to 6 carbon atoms, each of R³ represents one of a monovalent hydrocarbon group having 1 to 6 carbon atoms, a halogen atom, and a reactive functional group. Examples of the hydrocarbon group include an alkyl group, an alkenyl group, an aryl group, and the like. Examples of the alkyl group include a methyl group, an ethyl group, a propyl group, a butyl group, and the like. Examples of the alkenyl group include a vinyl group, an allyl group, and the like. Examples of the aryl group include a phenyl group and the like. Examples of the halogen atom include a chlorine atom, a bromine atom, and the like. Examples of the reactive functional group include a hydroxyl group, a carbinol group, an amino group, an isocyanate group, a carboxyl group, a substituent derived from a carboxyl group, an alkoxy group, a mercapto group, a sulfo group, a substituent derived from a sulfo group, a sulfinic acid group, a hydrido group, a vinyl group, and the like.

It is preferable that R³ individually be monovalent hydrocarbon groups having 1 to 6 carbon atoms. If R³ is a monovalent hydrocarbon group having 1 to 6 carbon atoms, the resulting silicon-containing polymer exhibits excellent heat resistance.

It is preferable that R² and R³ be methyl groups.

Each of Z in the formula (5) represents a halogen atom or a reactive functional group. Examples of the halogen atom include a chlorine atom, a bromine atom, and the like. Examples of the reactive functional group include a hydroxyl group, a carbinol group, an amino group, an isocyanate group, a carboxyl group, a substituent derived from a carboxyl group, an alkoxy group, a mercapto group, a sulfo group, a substituent derived from a sulfo group, a sulfinic acid group, a hydrido group, a vinyl group, and the like. The polyorganosiloxane (a2) may include one or more types of reactive functional groups as Z.

The polyorganosiloxane (a2) preferably includes an alkoxy group, a carboxyl group, a hydrido group, or a hydroxyl group as the reactive functional group. Specifically, it is preferable that at least one of R², R³, and Z in the formula (5) be a reactive functional group. If the polyorganosiloxane (a2) includes a reactive functional group, excellent coupling reactivity can be obtained. It is particularly preferable that at least one Z be a reactive functional group.

m is a positive integer. m is preferably an integer from 5 to 10,000.

Specific examples of the polyorganosiloxane (a2) include a polydimethylsiloxane including a reactive functional group at its end, a polydimethylsiloxane including a reactive functional group in the side chain, and the like.

The polydimethylsiloxane may have a branched structure in which the siloxane skeleton (main chain) branches.

A polydimethylsiloxane including a reactive functional group at its end may be produced by subjecting a dimethyldialkoxysilane or dimethyldichlorosilane to hydrolysis and condensation, and reacting the resulting product with a silicone coupling agent via a coupling reaction, for example.

Examples of the dimethyldialkoxysilane include dimethyldimethoxysilane, dimethyldiethoxysilane, dimethyldi-i-propoxysilane, dimethyldi-n-butoxysilane, and the like. These dimethyldialkoxysilanes may be used either individually or in combination.

A polydimethylsiloxane including a reactive functional group at its end may also be produced by subjecting a cyclic organosiloxane to ring-opening condensation, and reacting the resulting product with a silicone coupling agent via a coupling reaction. Specific examples of the cyclic organosiloxane include hexaphenylcyclotrisiloxane, octaphenylcyclotetrasiloxane, tetravinyltetramethylcyclotetrasiloxane, hexamethylcyclotrisiloxane, octamethylcyclotetrasiloxane, pentamethylcyclotetrasiloxane, hexamethylcyclotetrasiloxane, tetramethylcyclotetrasiloxane, decamethylcyclopentasiloxane, dodecamethylcyclohexasiloxane, and the like.

A polydimethylsiloxane including a reactive functional group in the side chain may be produced by reacting a polydimethylsiloxane that includes an SiH group with a compound that includes a vinyl bond and a reactive functional group in one molecule, for example.

It is preferable to use a polydimethylsiloxane including a reactive functional group at its end as the polyorganosiloxane (a2). If the polyorganosiloxane (a2) includes a reactive functional group at its end, excellent coupling reactivity can be obtained as compared with the case where the polyorganosiloxane (a2) includes a reactive functional group in the side chain. Moreover, the composition produces a small number of defects during curing, so that a tough film can be obtained.

It is particularly preferable to use a polydimethylsiloxane that includes a silanol group at its end as the polyorganosiloxane (a2). The polystyrene-reduced weight average molecular weight of the polydimethylsiloxane that includes a silanol group at its end determined by gel permeation chromatography is preferably 100 to 1,000,000, more preferably 200 to 500,000, and particularly preferably 300 to 100,000. If the polydimethylsiloxane that includes a silanol group at its end has a weight average molecular weight within the above range, a hybrid polymer that has a well-balanced viscosity and thick film formability can be obtained.

A commercially available modified silicone may be used as the polydimethylsiloxane including a reactive functional group at its end. Examples of a siloxane having silanol-modified ends include a polydimethylsiloxane including a silanol group at each end, such as YF-3057, YF-3800, YF-3802, YF-3807, YF-3897, and XF-3905 (manufactured by GE Toshiba Silicones Co., Ltd.).

### Coupling Reaction

A hybrid polymer is obtained by subjecting the compound (a1) and the polyorganosiloxane (a2) to a coupling reaction. The resulting hybrid polymer may be capped using a silicone coupling agent such as trimethylchlorosilane.

The compound (a1) and the polyorganosiloxane (a2) are preferably subjected to a coupling reaction in a weight ratio of 5:95 to 70:30. The weight ratio is more preferably 10:90 to 60:40, and particularly preferably 15:85 to 50:50. If the weight ratio is within the above range, the coupling reaction efficiency increases, so that a hybrid polymer having a high molecular weight is obtained. This makes it possible to obtain a cured product that exhibits excellent heat resistance.

The coupling reaction temperature is preferably −50 to 100° C., more preferably −30 to 80° C., and particularly preferably −10 to 50° C. The reaction time is preferably 1 to 48 hours, more preferably 1 to 24 hours, and particularly preferably 2 to 12 hours. The compound (a1) and the polyorganosiloxane (a2) may be added to a reaction container all together, and subjected to a coupling reaction, or may be subjected to a coupling reaction while continuously or intermittently adding one component to the other component. The compound (a1) and the polyorganosiloxane (a2) are preferably subjected to a coupling reaction in an organic solvent using a catalyst.

### Organic Solvent

Examples of the organic solvent used for the coupling reaction include alcohols, aromatic hydrocarbons, ethers, ketones, esters, and the like. Examples of the alcohols include methanol, ethanol, n-propyl alcohol, i-propyl alcohol, i-butyl alcohol, n-butyl alcohol, sec-butyl alcohol, t-butyl alcohol, n-hexyl alcohol, n-octyl alcohol, ethylene glycol, diethylene glycol, triethylene glycol, ethylene glycol monobutyl ether, ethylene glycol monoethyl ether acetate, diethylene glycol monoethyl ether, propylene glycol methyl ether, propylene monomethyl ether acetate, diacetone alcohol, and the like. Examples of the aromatic hydrocarbons include benzene, toluene, xylene, and the like. Examples of the ethers include tetrahydrofuran, dioxane, and the like. Examples of the ketones include acetone, methyl ethyl ketone, methyl isobutyl ketone, diisobutyl ketone, and the like. Examples of the esters include ethyl acetate, propyl acetate, butyl acetate, propylene carbonate, methyl lactate, ethyl lactate, n-propyl lactate, isopropyl lactate, methyl 3-ethoxypropionate, ethyl 3-ethoxypropionate, and the like. These organic solvents may be used either individually or in combination. Among these organic solvents,it is preferable to use a non-alcohol organic solvent (e.g., methyl ethyl ketone, methyl isobutyl ketone, toluene, or xylene) for the coupling reaction from the viewpoint of solubility.

The organic solvent may be appropriately used to control the coupling reaction, for example. The amount of organic solvent may be appropriately determined depending on the desired conditions.

### Catalyst

Examples of the catalyst used for the coupling reaction include a basic compound, an acidic compound, and a transition metal or a transition metal compound.

### Basic Compound

Examples of the basic compound include ammonia (including aqueous ammonia), an organic amine compound, an alkali metal/alkaline earth metal hydroxide (e.g., sodium hydroxide and potassium hydroxide), and an alkali metal alkoxide (e.g., sodium methoxide and sodium ethoxide). Among these, ammonia and the organic amine compound are preferable.

Examples of the organic amine include an alkylamine, an alkoxyamine, an alkanolamine, an arylamine, and the like.

Examples of the alkylamine include alkylamines including an alkyl group having 1 to 4 carbon atoms, such as methylamine, ethylamine, propylamine, butylamine, aminohexane, octylamine, N,N-dimethylamine, N,N-diethylamine, N,N-dipropylamine, N,N-dibutylamine, trimethylamine, triethylamine, tripropylamine, and tributylamine, and the like.

Examples of the alkoxyamine include alkoxyamines including an alkoxy group having 1 to 4 carbon atoms, such as methoxymethylamine, methoxyethylamine, methoxypropylamine, methoxybutylamine, ethoxymethylamine, ethoxyethylamine, ethoxypropylamine, ethoxybutylamine, propoxymethylamine, propoxyethylamine, propoxypropylamine, propoxybutylamine, butoxymethylamine, butoxyethylamine, butoxypropylamine, and butoxybutylamine, and the like.

Examples of the alkanolamine include alkanolamines including an alkyl group having 1 to 4 carbon atoms, such as methanolamine, ethanolamine, propanolamine, butanolamine, N-methylmethanolamine, N-ethylmethanolamine, N-propylmethanolamine, N-butylmethanolamine, N-methylethanolamine, N-ethylethanolamine, N-propylethanolamine, N-butylethanolamine, N-methylpropanolamine, N-ethylpropanolamine, N-propylpropanolamine, N-butylpropanolamine, N-methylbutanolamine, N-ethylbutanolamine, N-propylbutanolamine, N-butylbutanolamine, N,N-dimethylmethanolamine, N,N-diethylmethanolamine, N,N-dipropylmethanolamine, N,N-dibutylmetanolamine, N,N-dimethylethanolamine, N,N-diethylethanolamine, N,N-dipropylethanolamine, N,N-dibutylethanolamine, N,N-dimethylpropanolamine, N,N-diethylpropanolamine, N,N-dipropylpropanolamine, N,N-dibutylpropanolamine, N,N-dimethylbutanolamine, N,N-diethylbutanolamine, N,N-dipropylbutanolamine, N,N-dibutylbutanolamine, N-methyldimethanolamine, N-ethyldimethanolamine, N-propyldimethanolamine, N-butyldimethanolamine, N-methyldiethanoleamine, N-ethyldiethanolamine, N-propyldiethanolamine, N-butyldiethanolamine, N-methyldipropanolamine, N-ethyldipropanolamine, N-propyldipropanolamine, N-butyldipropanolamine, N-methyldibutanolamine, N-ethyldibutanolamine, N-propyldibutanolamine, N-butyldibutanolamine, N-(aminomethyl)methanolamine, N-(aminomethyl)ethanolamine, N-(aminomethyl)propanolamine, N-(aminomethyl)butanolamine, N-(aminoethyl)methanolamine, N-(aminoethyl)ethanolamine, N-(aminoethyl)propanolamine, N-(aminomethyl)butanolamine, N-(aminopropyl)methanolamine, N-(aminopropyl)ethanolamine, N-(aminopropyl)propanolamine, N-(aminopropyl)butanolamine, N-(aminobutyl)methanolamine, N-(aminobutyl)ethanolamine, N-(aminobutyl)propanolamine, and N-(aminobutyl)butanolamine.

Examples of the arylamine include aniline, N-methylaniline, and the like.

Examples of other organic amines include tetraalkylammonium hydroxides such as tetramethylammonium hydroxide, tetraethylammonium hydroxide, tetrapropylammonium hydroxide, and tetrabutylammonium hydroxide; tetraalkylethylenediamines such as tetramethylethylenediamine, tetraethylethylenediamine, tetrapropylethylenediamine, and tetrabuthylethylenediamine; alkylaminoalkylamines such as methylaminomethylamine, methylaminoethylamine, methylaminopropylamine, methylaminobutylamine, ethylaminomethylamine, ethylaminoethylamine, ethylaminopropylamine, ethylaminobutylamine, propylaminomethylamine, propylaminoethylamine, propylaminopropylamine, propylaminobutylamine, butylaminomethylamine, butylaminoethylamine, butylaminopropylamine, and butylaminobutylamine; pyridine, pyrrole, piperazine, pyrrolidine, piperidine, picoline, morpholine, methylmorpholine, diazabicyclooctane, diazabicyclononane, diazabicycloundecene, and the like.

These basic compounds may be used either individually or in combination. Among these, triethylamine, pyrrolidine, tetramethylammonium hydroxide, and pyridine are particularly preferable.

### Acidic Compound

Examples of the acidic compound include an organic acid and an inorganic acid. Examples of the organic acid include acetic acid, propionic acid, butanoic acid, pentanoic acid, hexanoic acid, heptanoic acid, octanoic acid, nonanoic acid, decanoic acid, oxalic acid, maleic acid, maleic anhydride, methylmalonic acid, adipic acid, sebacic acid, gallic acid, butyric acid, mellitic acid, arachidonic acid, shikimic acid, 2-ethylhexanoic acid, oleic acid, stearic acid, linolic acid, linoleic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, methanesulfonic acid, phthalic acid, fumaric acid, citric acid, tartaric acid, and the like. Examples of the inorganic acid include hydrochloric acid, nitric acid, sulfuric acid, hydrofluoric acid, phosphoric acid, and the like.

These acidic compounds may be used either individually or in combination. Among these acidic compounds, oxalic acid, maleic acid, hydrochloric acid, and sulfuric acid are particularly preferable.

### Transition Metal and Transition Metal Compound

Examples of the transition metal or compound include platinum, a compound obtained by dispersing platinum on a support (e.g., alumina, silica, or carbon black), chloroplatinic acid, a complex of chloroplatinic acid and an alcohol, aldehyde, ketone, or the like, a platinum-olefin complex, and a platinum(0)-divinyltetramethyldisiloxane complex. Examples of a catalyst other than the platinum compounds include RhCl(PPh₃)₃, RhCl₃, RuCl₃, IrCl₃, FeCl₃, AlCl₃, PdCl₂.H₂O, NiCl₂, TiCl₄, and the like. These catalysts may be used either individually or in combination.

A reaction inhibitor may be used together with the catalyst in order to prevent gelation. It is preferable to use acetylene alcohol (i.e., preferably 1-buten-2-ol) as the reaction inhibitor

The catalyst is used for the coupling reaction in an amount of 0.01 to 100 parts by weight, and preferably 0.1 to 50 parts by weight, based on 100 parts by weight of polydimethylsiloxane.

### Catalyst Removal Step

After completion of the coupling reaction, it is preferable to remove the catalyst (catalyst removal step) by washing with water from the viewpoint of the storage stability of the hybrid polymer. When using the basic compound as the catalyst, it is preferable to perform neutralization with an acidic compound after the reaction before removing the catalyst by washing with water.

Examples of the acidic compound used for neutralization include an organic acid and an inorganic acid. Examples of the organic acid include acetic acid, propionic acid, butanoic acid, pentanoic acid, hexanoic acid, heptanoic acid, octanoic acid, nonanoic acid, decanoic acid, oxalic acid, maleic acid, maleic anhydride, methylmalonic acid, adipic acid, sebacic acid, gallic acid, butyric acid, mellitic acid, arachidonic acid, shikimic acid, 2-ethylhexanoic acid, oleic acid, stearic acid, linolic acid, linoleic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, methanesulfonic acid, phthalic acid, fumaric acid, citric acid, tartaric acid, and the like. Examples of the inorganic acid include hydrochloric acid, nitric acid, sulfuric acid, hydrofluoric acid, phosphoric acid, and the like.

The acidic compound is normally used in an amount of 0.5 to 2 N, preferably 0.8 to 1.5 N, and more preferably 0.9 to 1.3 N, based on 1 N of the basic compound used for coupling reaction. It is preferable to use a water-soluble acidic compound since the acidic compound is easily extracted into an aqueous layer during washing with water. When using the acidic compound in the form of an aqueous solution, the acidic compound is normally added to water in an amount of 0.5 to 100 parts by weight, preferably 1 to 50 parts by weight, and more preferably 2 to 10 parts by weight, based on 100 parts by weight of water.

After completion of neutralization, the mixture is sufficiently stirred, and allowed to stand. After the mixture has been separated into an aqueous phase and an organic solvent phase, water is removed from the lower layer.

Water is normally used for washing in an amount of 10 to 500 parts by weight, preferably 20 to 300 parts by weight, and more preferably 30 to 200 parts by weight, based on 100 parts by weight of the hybrid polymer.

The washing operation is performed as follows. After the addition of water, the mixture is sufficiently stirred, and allowed to stand. After the mixture has been separated into an aqueous phase and an organic solvent phase, water is removed from the lower layer. The washing operation is preferably performed at least once (more preferably twice or more).

After completion of washing with water, extraction with an organic solvent may be performed to remove impurities. The above organic solvents may be used for extraction. The type and the amount of organic solvent may be appropriately selected.

### Curing Agent (B)

Examples of the curing agent (B) include a transition metal, a transition metal compound, and a metal chelate compound. Examples of the transition metal or compound include the transition metals or compounds mentioned above in connection with the coupling reaction. These transition metals or compounds may be used either individually or in combination.

Specific examples of the transition metal or compound include platinum, a compound obtained by dispersing platinum on a support (e.g., alumina, silica, or carbon black), chloroplatinic acid, a complex of chloroplatinic acid and an alcohol, aldehyde, ketone, or the like, a platinum-olefin complex, and a platinum(0)-divinyltetramethyldisiloxane complex. Examples of a catalyst other than the platinum compounds include RhCl(PPh₃)₃, RhCl₃, RuCl₃, IrCl₃, FeCl₃, AlCl₃, PdCl₂.H₂O, NiCl₂, TiCl₄, and the like. These catalysts may be used either individually or in combination.

Examples of the metal chelate compound include zirconium chelate compounds such as tri-n-butoxy-(ethylacetoacetate)zirconium, di-n-butoxy-bis(ethylacetoacetate)zirconium, n-butoxy-tris(ethylacetoacetate)zirconium, tetrakis(n-propylacetoacetate)zirconium, tetrakis(acetylacetoacetate)zirconium, and tetrakis(ethylacetoacetate)zirconium; titanium chelate compounds such as di-i-propoxy-bis(ethylacetoacetate)titanium, di-i-propoxy-bis(acetylacetate)titanium, and di-i-propoxy-bis(acetylacetone)titanium; aluminum chelate compounds such as di-i-propoxy-(ethylacetoacetate)aluminum, di-i-propoxy-(acetylacetonate)aluminum, i-propoxy-bis(ethylacetoacetate)aluminum, i-propoxy-bis(acetylacetonate)aluminum, tris(ethylacetoacetate)aluminum, tris(acetylacetonato)aluminum, and monoacetylacetonato-bis(ethylacetoacetate)aluminum; and the like. Among these, the aluminum chelate compounds are preferable from the viewpoint of the curability and the moisture-heat resistance of the resulting cured product.

The curing agent (B) is normally used in an amount of 0.00001 to 0.1 parts by weight, preferably 0.00001 to 0.01 parts by weight, and particularly preferably 0.0001 to 0.005 parts by weight, based on 100 parts by weight of the silicon-containing polymer (A). If the amount of the metal compound is within the above range, well-balanced liquid stability and curability can be achieved after adding the metal compound.

### Other Components

The composition may further include silica particles, an epoxy group-containing polysiloxane, an oxetane compound, a thiol compound, a compound including an isocyanuric ring structure, an alkoxysilane, a hydrolysate or a condensate thereof, and the like.

It is preferable that the composition include additives such as a filler or a fluorescent material. For example, the strength of the resulting cured product can be improved by adding a filler or the like. The composition may be used as an LED sealing material by adding a fluorescent material.

When adding silica particles to the composition, silica particles may be used in the form of a powder, a solvent sol prepared by dispersing silica particles in a polar solvent (e.g., isopropyl alcohol) or a non-polar solvent (e.g., toluene), a colloid, or the like. When using silica particles in the form of a solvent sol or colloid, the solvent is removed after adding the solvent sol or colloid. Silica particles may be surface-treated in order to improve the dispersibility of the silica particles.

The primary particle diameter of the silica particles is normally 0.0001 to 1 μm, preferably 0.001 to 0.5 μm, and particularly preferably 0.002 to 0.2 μm.

When using silica particles in the form of a solvent sol or colloid, the solid content is normally more than 0 wt % and 50 wt % or less, and preferably 0.01 to 40 wt %.

Examples of untreated powdery silica include #150, #200, #300 (manufactured by Nippon Aerosil Co., Ltd.), and the like. Examples of hydrophobic powdery silica include R972, R974, R976, RX200, RX300, RY200S, RY300, R106 (manufactured by Nippon Aerosil Co., Ltd.), 5550A (manufactured by Tosoh Corp.), Sylophobic 100 (manufactured by Fuji Silysia Chemical, Ltd.), and the like.

Examples of solvent dispersion colloidal silica include alcohol solvent (e.g., isopropyl alcohol) dispersion colloidal silica (e.g., manufactured by Nissan Chemical Industries, Ltd.), ketone solvent (e.g., methyl isobutyl ketone) dispersion colloidal silica, non-polar solvent (e.g., toluene) dispersion colloidal silica, and the like.

The silica particles may be added when or after producing the silicon-containing polymer (A).

The silica particles are normally used in an amount (solid content) of more than 0 wt % and 80 wt % or less, and preferably 5 to 50 wt %, based on the solid content of the silicon-containing polymer (A).

Examples of the oxetane compound include compounds shown by the following formulas (O-1) to (O-10).

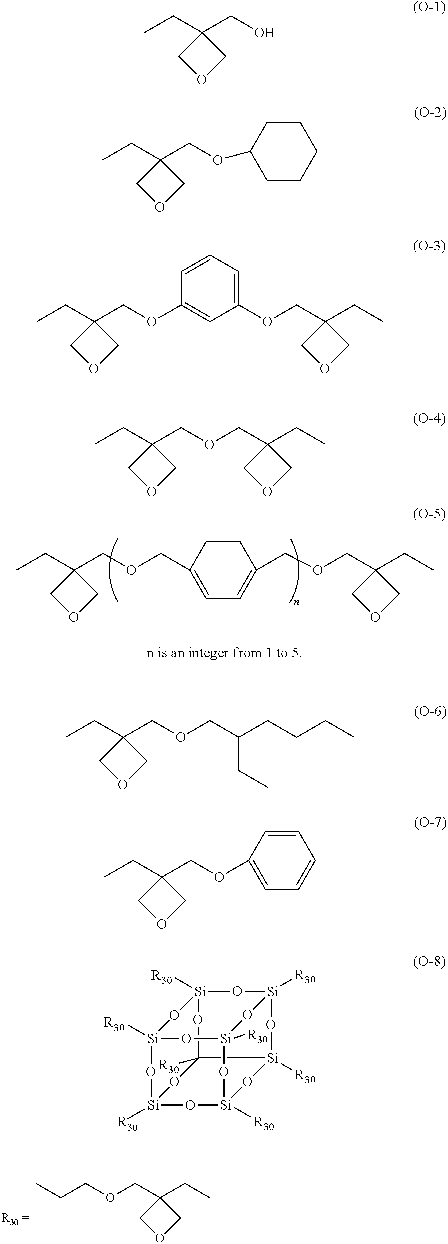

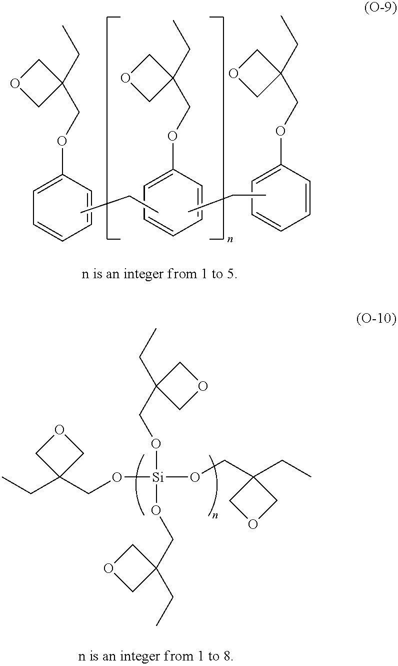

Examples of the thiol compound include 3-mercaptopropyltrimethoxysilane, 3-mercaptopropyltriethoxysilane, 3-mercaptopropyl-tri-n-propoxysilane, 3-mercaptopropyl-tri-i-propoxysilane, 3-mercaptopropyltri-n-butoxysilane, 3-mercaptopropyl-tri-sec-butoxysilane, and the like.

Examples of the compound including an isocyanuric ring structure include tris(3-trimethoxysilyl-n-propyl) isocyanurate, tris(2-hydroxyethyl) isocyanurate, triglycidyl isocyanurate, and the like.

Examples of the alkoxysilane or a hydrolysate or a condensate thereof include the compound shown by the formula (2) or a hydrolysate or a condensate thereof. Examples of the condensate of the compound shown by the formula (2) include a condensate of the above alkoxysilane and a condensate of two or more alkoxysilanes (e.g., a tetramethoxysilane oligomer, a tetraethoxysilane oligomer, a methyltrimethoxysilane oligomer, and a condensate of methyltrimethoxysilane and dimethyldimethoxysilane).

The silica particles, the epoxy group-containing polysiloxane, the oxetane compound, the thiol compound, the compound including an isocyanuric ring structure, the alkoxysilane, or a hydrolysate or a condensate thereof may be added when synthesizing the hybrid polymer, or may be added when producing a cured product.

The composition according to one embodiment of the invention is cured by heating. It is conjectured that the silicon-containing polymer (A) (i.e., cyclic carbosilane) undergoes a ring-opening reaction due to the metal catalyst to form a crosslinked structure.

### <Cured Product>

A cured product according to one embodiment of the invention is produced by curing the above composition. Since the composition does not include an acid generator (e.g., onium salt), a cured product exhibiting excellent transparency can be obtained. In particular, since the composition includes a large amount of linear polydimethylsiloxane components, stress can be reduced due to flexibility (i.e., a thick film can be formed). Therefore, the above cured product may be suitably used as an LED sealing material.

The cured product may be produced by the following method.

Specifically, the composition is applied to a substrate by spin coating, dipping, roll coating, spray coating, or the like. The composition may be applied to a thickness of from about several nanometers to about 10 mm.

The composition is then normally dried at 50 to 200° C., preferably 80 to 180° C., and more preferably 100 to 150° C. for about 30 to 60 minutes to obtain a cured product.

A hot plate, an oven, a furnace, or the like may be used as the heating means. The composition may be heated in air, nitrogen, or argon, or under vacuum, or under reduced pressure at a controlled oxygen concentration. In order to control the curing speed of the composition (coating), the composition may be heated stepwise, or may be heated in a desired atmosphere (e.g., nitrogen, air, oxygen, or under reduced pressure).

The cured product according to one embodiment of the invention exhibits excellent adhesion to a substrate formed of an organic or inorganic polymer material. In particular, the cured product exhibits excellent adhesion to polyethylene, polypropylene, polystyrene, polyacrylonitrile, polyphenol, polyphthalamide, polyimide, polyether, and glass.

### Application of Composition and Cured Product

The above composition or a cured product thereof is useful as an LED sealing material (particularly as a blue LED sealing material or a UV LED sealing material), and may also be used as a display material, an optical recording material, an optical instrument material, an optical component material, an optical fiber material, an optical/electronic functional organic material, a semiconductor integrated circuit peripheral material, and the like due to excellent heat resistance, UV resistance, transparency, and the like.

### 1. Display Material

Examples of the display material include a liquid crystal display device peripheral material (e.g., substrate material, light-guiding plate, prism sheet, deflector plate, retardation plate, viewing angle correction film, adhesive, and polarizer protective film (i.e., liquid crystal film); a sealing material, an antireflective film, an optical correction film, a housing material, a front glass protective film, a front glass alternative material, an adhesive, and the like for a color plasma display (PDP) (next-generation flat panel display); a substrate material, a light-guiding plate, a prism sheet, a deflector plate, a retardation plate, a viewing angle correction film, an adhesive, a polarizer protective film, and the like for a plasma address liquid crystal (PALC) display; a front glass protective film, a front glass alternative material, an adhesive, and the like for an organic electroluminescence (EL) display; and a film substrate, a front glass protective film, a front glass alternative material, an adhesive, and the like for a field emission display (FED).

### 2. Optical Recording Material

Examples of the optical recording material include a disk structure material, a pickup lens, a protective film, a sealing material, an adhesive, and the like for a VD (video disk), CD, CD-ROM, CD-R/CD-RW, DVD±R/DVD±RW/DVD-RAM, MO, MD, PD (phase-change disk), and optical card.

### 3. Optical Instrument Material

Examples of the optical instrument material include a lens material, a finder prism, a target prism, a finder cover, a light-receiving sensor, and the like for a still camera; a lens, a finder, and the like for a video camera; a projection lens, a protective film, a sealing material, an adhesive, and the like for a projection TV; and a lens material, a sealing material, an adhesive, a film, and the like for an optical sensing instrument.

### 4. Optical Component Material

Examples of the optical component material include a fiber material, a lens, a waveguide, an element sealing material, an adhesive, and the like for an optical switch used for an optical communication system; an optical fiber material, a ferrule, a sealing material, an adhesive, and the like for an optical connecter; a sealing material, an adhesive, and the like for an optical passive component and an optical circuit component (e.g., lens, waveguide, and LED element); and a substrate material, a fiber material, an element sealing material, an adhesive, and the like for an optoelectronic integrated circuit (OEIC).

### 5. Optical Fiber Material

Examples of the optical fiber material include lighting, a light guide, and the like for a decoration display; an industrial sensor, display, label, and the like; an optical fiber used for a communication infrastructure and domestic digital device connection applications; and the like.

### 6. Semiconductor Integrated Circuit Peripheral Material

Examples of the semiconductor integrated circuit peripheral material include a resist material for microlithography of an LSI and VLSI material, and the like.

### 7. Optical/Electronic Functional Organic Material

Examples of the optical/electronic functional organic material include an organic EL device peripheral material and an organic photorefractive element; a substrate material for an optical amplification element, an optical calculation element, and an organic solar cell (optical conversion device); a fiber material; and a sealing material, an adhesive, and the like for these elements or devices.

### EXAMPLES

The embodiment of the invention is further described below by way of examples. Note that the invention is not limited to the following examples. In the examples and comparative examples, the units “parts” and “%” respectively refer to “parts by weight” and “wt %” unless otherwise indicated. The following measuring methods were used in the examples and comparative examples.

### (1) Curability

The composition was applied to quartz glass so that the thickness of the dried film was 1 mm, dried/cured at 100° C. for 1 hour, and dried/cured at 150° C. for 5 hours to obtain a cured product. The curability of the cured product was evaluated in accordance with the following standard.
A: No fluidity and tackiness were observed.
B: No fluidity was observed, but slight tackiness was observed.
C: Fluidity was observed.
D: Cracks occurred.

### (2) Transparency

The composition was applied to quartz glass so that the thickness of the dried film was 1 mm, dried/cured at 100° C. for 1 hour, and dried/cured at 150° C. for 5 hours to obtain a cured product. The spectral transmittance (wavelength: 400 to 700 nm) of the cured product was measured using a UV spectrophotometer, and evaluated in accordance with the following standard.
A: The transmittance was higher than 90%.
B: The transmittance was 70 to 90%.
C: The transmittance was less than 70%.

### (3) Light Resistance

The composition was applied to quartz glass so that the thickness of the dried film was 1 mm, dried/cured at 100° C. for 1 hour, and dried/cured at 150° C. for 5 hours to obtain a cured product. UV rays were applied to the cured product for 500 hours using a spot UV irradiation apparatus (SP-VII manufactured by Ushio Inc., light having a wavelength of 350 nm or less was cut off) (illuminance: 5000 mW/cm²). The appearance of the cured product was observed with the naked eye after applying UV rays, and evaluated in accordance with the following standard.
A: No change was observed.
B: Yellowing was observed.
C: A scorch was observed.

### (4) Heat Resistance

The composition was applied to quartz glass so that the thickness of the dried film was 1 mm, dried/cured at 100° C. for 1 hour, and dried/cured at 150° C. for 5 hours to obtain a cured product. The cured product was stored at 150° C. for 500 hours. The appearance of the cured product was observed with the naked eye after storage, and evaluated in accordance with the following standard.

### (Change in Color)

A: No change was observed.
B: A slight change was observed.
C: Yellowing was observed.

### (Cracks)

A: No cracks were observed.
B: A small number of cracks were observed.
C: Cracks occurred over the entire surface of the cured product.

### (5) Moisture-Heat Resistance

About 2 g of the composition was precisely weighed on an aluminum dish, dried/cured at 100° C. for 1 hour, and dried/cured at 150° C. for 5 hours to obtain a cured product. The cured product was stored at a temperature of 85° C. and a relative humidity of 85% for 14 days. The ratio (weight retention rate) of the weight of the cured product after storage to the weight of the cured product before storage was calculated, and the moisture-heat resistance of the cured product was evaluated based on the weight retention rate in accordance with the following standard.
A: 99% or more
B: 95% or more and less than 99%
C: Less than 95%

### (6) Silver Blackening Suppression Capability (Evaluation of Gas Barrier Properties)

The composition was applied to silver plating using an applicator so that the thickness of the dried film was 100 μm, and dried at a given temperature to obtain a silver blackening suppression capability evaluation sample.

After mixing 0.06 g of iron sulfide and 0.20 g of sulfuric acid in a pressure vessel (volume: 150 cm³), the sample was immediately put into the pressure vessel, and the pressure vessel was sealed (theoretical hydrogen sulfide concentration: 10 vol %). The pressure vessel was heated at 120° C. for 5 hours, and then cooled. The sample was removed from the pressure vessel, and the appearance of the silver plating was observed. The silver blackening suppression capability was evaluated in accordance with the following standard.
A: No change in color was observed.
B: A slight change in color was observed.
C: Blackening was observed.

### (7) Adhesion

The composition was applied to a polyphthalamide substrate so that the thickness of the dried film was 1 mm, and dried at a given temperature to obtain an adhesion evaluation sample.

The sample was allowed to stand in a thermo-hygrostat at a temperature of 85° C. and a relative humidity of 85% for 16 hours.

The sample was then immediately reflowed for 10 minutes using a solder reflow apparatus (260° C.). The adhesion between the sample and the substrate was observed using a microscope, and evaluated in accordance with the following standard.
A: No separation was observed.
B: Separation was observed.
C: Cracks occurred.

### (8) Hardness

The composition was dried/cured at 100° C. for 1 hour, and dried/cured at 150° C. for 5 hours to obtain a cured product. The hardness of the cured product was measured in accordance with JIS K 6253.

### Example 1

40 parts of polydimethylsiloxane including a silanol group at its end (FM9915 manufactured by Chisso Corporation, Mw=4000), 3 parts of 1,3-dimethyl-1,3-dichlorodisilacyclobutane (cyclic carbosilane), 1 part of pyridine (catalyst), and 100 parts of toluene (solvent) were mixed, and subjected to a condensation reaction at room temperature for 10 hours.

The reaction product was neutralized with 116 parts of a 6 wt % oxalic acid aqueous solution at room temperature for 1 hour. After separating the aqueous layer, the organic phase was washed with 200 parts of water. The washing operation was performed three times. The solvent was then evaporated to obtain a hybrid polymer (1) (Mw=10,000, weight ratio of carbosilane: 5%). A 3 wt % isopropyl alcohol solution of a platinum(0)-divinyltetramethyldisiloxane complex (curing agent) was added to 100 parts of the hybrid polymer (1) so that the content of platinum was 0.010 parts. The mixture was sufficiently stirred to prepare a composition (1). The curability, the transparency, the light resistance, the heat resistance, the moisture-heat resistance, the silver blackening suppression capability, the adhesion, and the hardness were evaluated as described above using the composition (1). The results are shown in Table 1.

### Example 2

A hybrid polymer (2) was obtained in the same manner as in Example 1, except for using 30 parts of polydimethylsiloxane including a silanol group at its end (XC96-723 manufactured by Momentive Performance Materials Inc., Mw=700) instead of 40 parts of polydimethylsiloxane including a silanol group at its end (FM9915 manufactured by Chisso Corporation, Mw=4000), and using 10 parts of 1,3-dimethyl-1,3-dichlorodisilacyclobutane (cyclic carbosilane) and 5 parts of pyridine (catalyst). The Mw of the hybrid polymer (2) was 3000, and the weight ratio of the carbosilane was 30%. A composition (2) was also prepared in the same manner as in Example 1.

The curability, the transparency, the light resistance, the heat resistance, the moisture-heat resistance, the silver blackening suppression capability, the adhesion, and the hardness were evaluated in the same manner as in Example 1 using the composition (2). The results are shown in Table 1.

### Examples 3 to 7 and Comparative Examples 1 and 2

A composition was obtained in the same manner as in Example 2 using the polydimethylsiloxane (a2) including a silanol group at its end (siloxane unit) and 1,3-dimethyl-1,3-dichlorodisilacyclobutane (a1) in a weight ratio shown in Table 2. The hardness and the curability were measured using the composition. The results are shown in Table 2. The hardness could not be measured due to insufficient curing (i.e., soft) when using 3 wt % of 1,3-dimethyl-1,3-dichlorodisilacyclobutane (a1), and could not be measured due to cracks (i.e., fragile) when using 80 wt % of 1,3-dimethyl-1,3-dichlorodisilacyclobutane (a1).

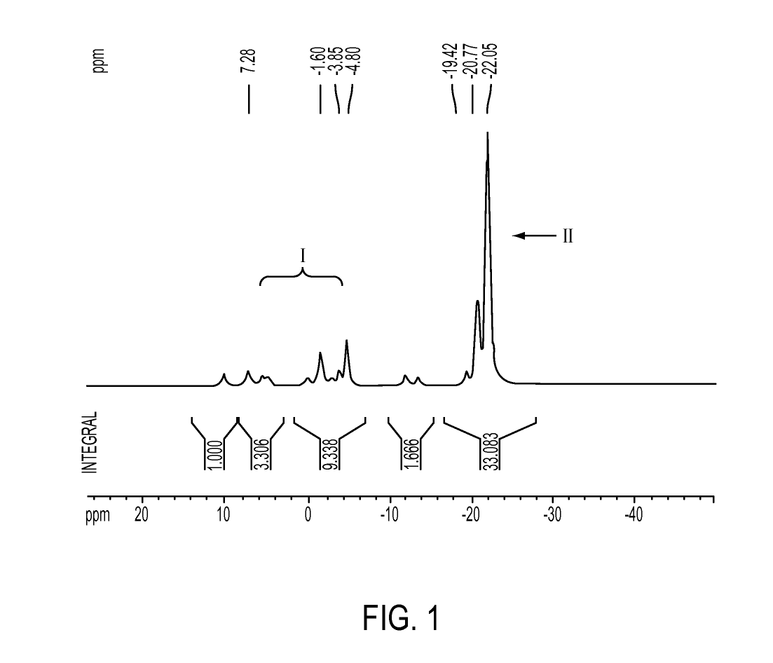

FIG. 1 shows the NMR analysis results for the hybrid polymer of Example 4. In FIG. 1, I indicates an M component region attributed to the carbosilane, and II indicates a D component region attributed to the silicone (skeleton). Table 3 shows the weight ratio of the structural unit (A1) to the structural unit (A2) included in the hybrid polymer based on the NMR analysis results.

Table 4 shows the weight ratio of the structural unit (A1) to the structural unit (A2) included in the hybrid polymers of Examples 3 to 6 based on the NMR analysis results.

### Comparative Example 3

A polymer and a composition were produced in the same manner as in Example 1, except for using a linear carbosilane (PCS-UH manufactured by Nippon Carbon Co., Ltd.) instead of the cyclic carbosilane so that the amount of the linear carbosilane was 70 parts based on 100 parts of toluene. A cured product having a thickness of 0.01 μm or more could not be obtained due to occurrence of cracks.

### Comparative Example 4

As a comparison of silver blackening suppression capability evaluation, 60 parts of an alicyclic epoxy resin (CE2021 manufactured by Daicel Chemical Industries), 66 parts of an acid anhydride (MH700 manufactured by New Japan Chemical Co., Ltd.), and 0.7 parts of a curing accelerator (UCAT18X manufactured by San-Apro Ltd.) were mixed, and sufficiently stirred. The mixture was applied to a Teflon® sheet so that the thickness of the dried film was 100 μm, and cured at 100° C. for 1 hour to obtain a cured product. The silver blackening suppression capability of the cured product was evaluated to be “C”.

A silicone sealing material (TSE3033A and TSE3033B manufactured by Momentive Performance Materials Inc., main component: linear polydimethylsiloxane) was applied to a commercially available surface-mount-type LED package (provided with silver plating) so that the thickness of the dried film was 100 μm, and dried at 150° C. for 5 hours to obtain a silver blackening suppression capability evaluation sample. The silver blackening suppression capability of the sample was evaluated to be “C”.

### Comparative Example 5

As an adhesion evaluation comparison, a silicone sealing material (TSE3033A and TSE3033B manufactured by Momentive Performance Materials Inc., main component: linear polydimethylsiloxane) was applied to polyphthalamide so that the thickness of the dried film was 100 μm, and dried at 150° C. for 5 hours to obtain an adhesion evaluation sample. The adhesion of the sample was evaluated to be “B”.

### Comparative Example 6

A polymer (3) was obtained in the same manner as in Example 1, except for using 10 parts of chloromethyldimethylsilane (linear carbosilane) instead of 10 parts of the cyclic carbosilane, and using 20 parts of polydimethylsiloxane including a silanol group at its end (XC96-723 manufactured by Momentive Performance Materials Inc., Mw=700) and 5 parts of pyridine (catalyst). A 3 wt % isopropyl alcohol solution of a platinum(0)-divinyltetramethyldisiloxane complex (curing agent) was added to 100 parts of the polymer (3) so that the content of platinum was 0.010 parts. The mixture was sufficiently stirred to prepare a composition (3). The composition (3) was heated at 150° C. for 6 hours. However, a cured product could not be obtained.

TABLE 1

| | | Example 1 | Example 2 |
|---|---|---|---|
| (1) Curability | | A | A |
| (2) Transparency | | A | A |
| (3) Light resistance | | A | A |
| (4) Heat resistance | Change in | A | A |
| | color | | |
| | Cracks | A | A |

| | | |
|---|---|---|
| (5) Moisture-heat resistance | A | A |
| (6) Gas barrier properties | B | B(+) |
| (7) Adhesion | A | A |

TABLE 2

| | | Comparative | | | | | | Comparative |
|---|---|---|---|---|---|---|---|---|
| | | Example 1 | Example 3 | Example 4 | Example 5 | Example 6 | Example 7 | Example 2 |
| Ratio (wt %) | a1 | 3 | 5 | 20 | 30 | 50 | 70 | 80 |
| | a2 | 97 | 95 | 80 | 70 | 50 | 30 | 20 |

| | | | | | | | |
|---|---|---|---|---|---|---|---|
| Hardness/Shore A | — | 5 | 30 | 40 | 50 | 80 | — |
| (1) Curability | B | A | A | A | A | A | D |

TABLE 3
Compositional ratio determined from NMR integral ratio

| | Carbosilane | Polydimethylsiloxane |
|---|---|---|
| Mw | | 700 |
| Mw unit. | 114 | 75 |
| Number of Si per molecule | 2 | 9.3 |
| NMR integral ratio | 9.388 | 33.083 |
| Molar ratio by NMR | 4.69 | 3.54 |
| Weight ratio | 535.12 | 2481.23 |
| Weight ratio (%) | 18 | 82 |
| | Raw material | 20% |
| | weight ratio | |
| | Theoretical polymer | 17.20% |
| | compositional ratio | |

TABLE 4

| | | Example 3 | Example 4 | Example 5 | Example 6 |
|---|---|---|---|---|---|
| Weight ratio | A1 | 5 | 18 | 26 | 41 |
| | A2 | 95 | 82 | 74 | 59 |

It is preferable that the structural unit (A2) included in the silicon-containing polymer (A) have a number average molecular weight of 100 to 1,000,000, and R² and R³ included in the structural unit (A2) be methyl groups.

It is preferable that R² and R³ included in the structural unit (A3) be methyl groups.

It is preferable that the polyorganosiloxane (a2) include an alkoxy group, a carboxyl group, a hydrido group, or a hydroxyl group as the reactive functional group, and R³ in the formula (5) individually be monovalent hydrocarbon groups having 1 to 6 carbon atoms.

The above composition according to the embodiment of the present invention exhibits excellent gas barrier properties and excellent adhesion to an organic substrate, and can produce a cured product having a large thickness. The cured product according to the embodiment of the present invention may be suitably used as an LED sealing material or the like.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A composition comprising:
a curing agent; and
a silicon-containing polymer comprising:
a structural unit (A1) shown by a following formula (1); and
a structural unit (A2) shown by a following formula (2), the structural unit (A1) and the structural unit (A2) having a weight ratio (A1):(A2) of 4:96 to 70:30, 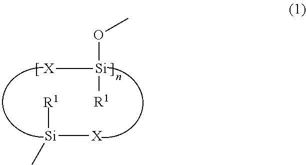
wherein each of R¹ represents a monovalent hydrocarbon group having 1 to 6 carbon atoms, each of X represents a divalent hydrocarbon group having 1 to 7 carbon atoms, and n is an integer from 1 to 6, 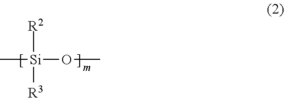
wherein R² represents a monovalent hydrocarbon group having 1 to 6 carbon atoms, R³ represents one of a monovalent hydrocarbon group having 1 to 6 carbon atoms, a halogen atom, and a reactive functional group, and m is a positive integer.

2. The composition according to claim 1, wherein the structural unit (A2) has a number average molecular weight of 100 to 1,000,000.

3. The composition according to claim 1, wherein each of the R² and the R³ included in the structural unit (A2) comprises a methyl group.

4. A composition comprising:
a curing agent; and
a silicon-containing polymer comprising a structural unit (A3) shown by a following formula (3), 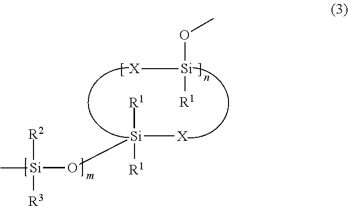
wherein each of R¹ represents a monovalent hydrocarbon group having 1 to 6 carbon atoms, each of X represents a divalent hydrocarbon group having 1 to 7 carbon atoms, each of R² and R³ represents a monovalent hydrocarbon group having 1 to 6 carbon atoms, n is an integer from 1 to 6, and m is a positive integer.

5. The composition according to claim 4, wherein each of the R² and the R³ included in the structural unit (A3) comprises a methyl group.

6. A cured product obtained by curing the composition according to claim 1.

7. A silicon-containing polymer comprising:
a structural unit (A1) shown by a following formula (1); and
a structural unit (A2) shown by a following formula (2), the structural unit (A1) and the structural unit (A2) having a weight ratio (A1):(A2) of 4:96 to 70:30, 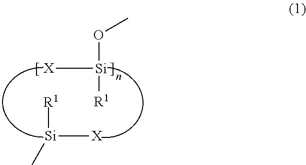
wherein each of R¹ represents a monovalent hydrocarbon group having 1 to 6 carbon atoms, each of X represents a divalent hydrocarbon group having 1 to 7 carbon atoms, and n is an integer from 1 to 6, 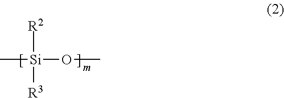
wherein R² represents a monovalent hydrocarbon group having 1 to 6 carbon atoms, R³ represents a monovalent hydrocarbon group having 1 to 6 carbon atoms, a halogen atom, or a reactive functional group, and m is a positive integer.

8. A method of producing a silicon-containing polymer, the method comprising:
reacting a compound shown by a following formula (4) with a polyorganosiloxane shown by a following formula (5), 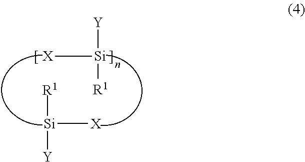
wherein each of R¹ represents a monovalent hydrocarbon group having 1 to 6 carbon atoms, each of X represents a divalent hydrocarbon group having 1 to 7 carbon atoms, Y represents a reactive functional group, and n is an integer from 1 to 6, 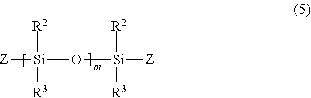
wherein each of R² represents a monovalent hydrocarbon group having 1 to 6 carbon atoms, each of R³ represents one of a monovalent hydrocarbon group having 1 to 6 carbon atoms, a halogen atom, and a reactive functional group, each of Z represents one of a halogen atom and a reactive functional group, and m is a positive integer.

9. The method according to claim 8, wherein the polyorganosiloxane comprises at least one of an alkoxy group, a carboxyl group, a hydrido group, and a hydroxyl group as the reactive functional group.

10. The method according to claim 8, wherein each of the R³ in the formula (5) comprises a monovalent hydrocarbon group having 1 to 6 carbon atoms.

11. The composition according to claim 2, wherein each of the R² and the R³ included in the structural unit (A2) comprises a methyl group.

12. A cured product obtained by curing the composition according to claim 2.

13. A cured product obtained by curing the composition according to claim 3.

14. A cured product obtained by curing the composition according to claim 4.

15. A cured product obtained by curing the composition according to claim 5.

16. A cured product obtained by curing the composition according to claim 11.

17. The method according to claim 8, wherein each of the R³ in the formula (5) comprises a monovalent hydrocarbon group having 1 to 6 carbon atoms.
